(19) United States
(12) Patent Application Publication
(10) Pub. No.: US 2003/0230716 A1
(43) Pub. Date: Dec. 18, 2003

(54) Multi-gas analyzer

(75) Inventors: Mark E. Russell, Central Point, OR (US); Martha E. Rykala, San Jose, CA (US)

Correspondence Address: MICHAEL B. EINSCHLAG, ESQ., 25680 FERNHILL DRIVE, LOS ALTOS HILLS, CA, 94024, US

(73) Assignee: Infrared Industries, Inc., Hayward, CA

(21) Appl. No.: 10/408,863

(22) Filed: Apr. 7, 2003

Related U.S. Application Data
(60) Provisional application No. 60/372,094, filed on Apr. 12, 2002.

(51) Int. Cl. G01N 21/61

(52) U.S. Cl. 250/339.13

(57) ABSTRACT

One embodiment of the present invention is an analyzer of a multiplicity of gases in a sample gas that includes: (a) an infrared source of infrared radiation; (b) a multiplicity of band-pass filters, including a reference band-pass filter, and an opaque area; (c) a movement mechanism that places the band-pass filters and the opaque area in front of the infrared radiation at predetermined times, and includes a location pickup mechanism; (d) a location pickup mechanism detector that generates movement mechanism timer signals; (e) a sample cell disposed in a path of the infrared radiation through which the sample gas travels; (f) a gas temperature sensor and a pressure transducer that generate temperature and a pressure signals; (g) a detector that detects infrared radiation that has passed through the sample cell and generates detector signals; and (h) a controller that analyzes the movement mechanism timer signals, the detector signals, the temperature signal, and the pressure signal to provide concentrations of the multiplicity of gases.

### This application claims the benefit of U.S. Provisional Application No. 60/372,094, filed on Apr. 12, 2002 which application is incorporated herein by reference.

### Technical Field of the Invention

One or more embodiments of the present invention pertain to a multi-gas analyzer.

### BACKGROUND OF THE INVENTION

As is known, multi-gas analyzers have been in use for years. Typically, such prior art multi-gas analyzers are comprised of handheld, one-to-five gas analyzers that measure one or more of hydrocarbons (“HC”), carbon monoxide (“CO”), carbon dioxide (“CO₂”), oxygen (“O₂”), and nitrogen oxide (“NOₓ”). Such prior art multi-gas analyzers are problematic for one or more of the following reasons: (a) they have slow response times, for example, five (5) seconds or greater; (b) they entail the use of disposable O₂ and NOₓ sensors that have a limited lifetime and a slow response; and (c) they are bulky.

In light of the above, there is a need in the art for a multi-gas analyzer that solves one or more of the above-identified problems.

### SUMMARY OF THE INVENTION

One or more embodiments of the present invention solve one or more of the above-identified problems. In particular, one embodiment of the present invention is an analyzer of a multiplicity of gases in a sample gas that comprises: (a) a source of infrared radiation; (b) a multiplicity of band-pass filters, including a reference band-pass filter, and an opaque area; (c) a movement mechanism that places the band-pass filters and the opaque area in front of the infrared radiation at predetermined times, and includes a location pickup mechanism; (d) a location pickup mechanism detector that detects the location pickup mechanism and generates movement mechanism timer signals; (e) a sample cell through which the sample gas travels, which sample cell is disposed in a path of the infrared radiation after it has passed through the band-pass filters; (f) a gas temperature sensor that detects a temperature of the sample gas in the sample cell and generates a temperature signal; (g) a pressure transducer that detects a pressure of the sample gas in the sample cell and generates a pressure signal; (h) a detector that detects infrared radiation that has passed through the sample cell and generates detector signals; and (i) a controller that analyzes the movement mechanism timer signals, the detector signals, the temperature signal, and the pressure signal to provide concentrations of the multiplicity of gases.

### BRIEF DESCRIPTION OF THE DRAWING

FIG. 1 is a perspective view of an analyzer cell used to fabricate a gas analyzer in accordance with one or more embodiments of the present invention;

FIG. 2 is an exploded view of the analyzer cell shown in FIG. 1;

FIG. 3 is a block diagram of a gas analyzer that is fabricated in accordance with one or more embodiments of the present invention;

FIG. 4 is a block diagram of a processing module that may be used to fabricate a gas analyzer in accordance with one or more embodiments of the present invention; and

FIG. 5 is a flowchart of a method used to determine concentrations of N gases in accordance with one or more embodiments of the present invention.

### DETAILED DESCRIPTION

One or more embodiments of the present invention are gas analyzers that measure concentrations of gases. In accordance with one or more such embodiments of the present invention, the concentrations of gases are expressed as a ratio of mass, for example and without limitation, in a percentage or as a parts-per-million (“PPM”).

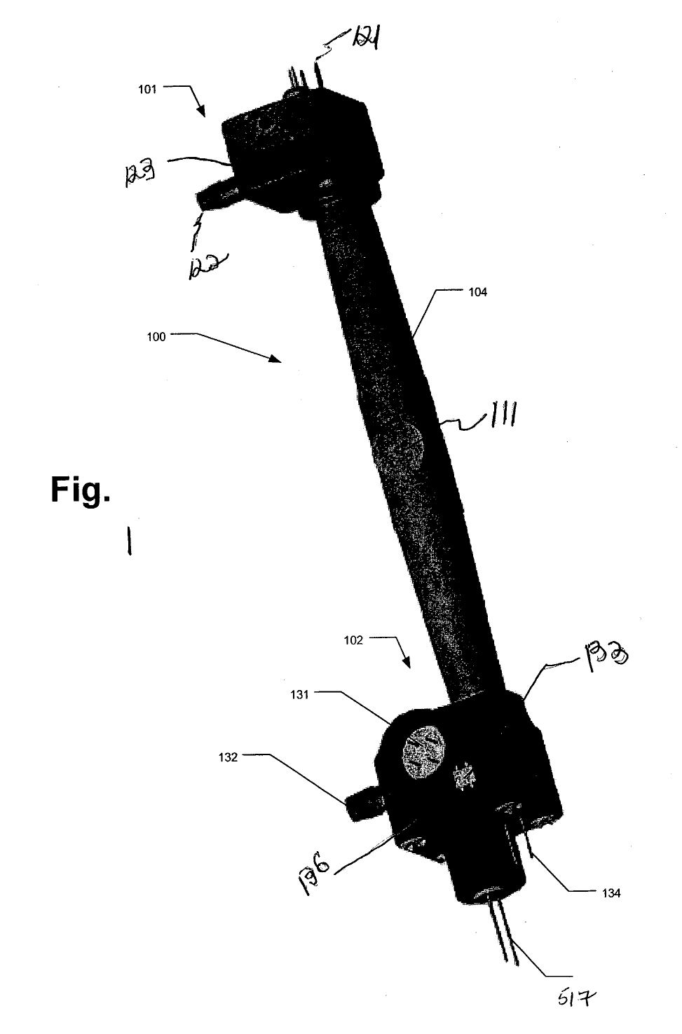

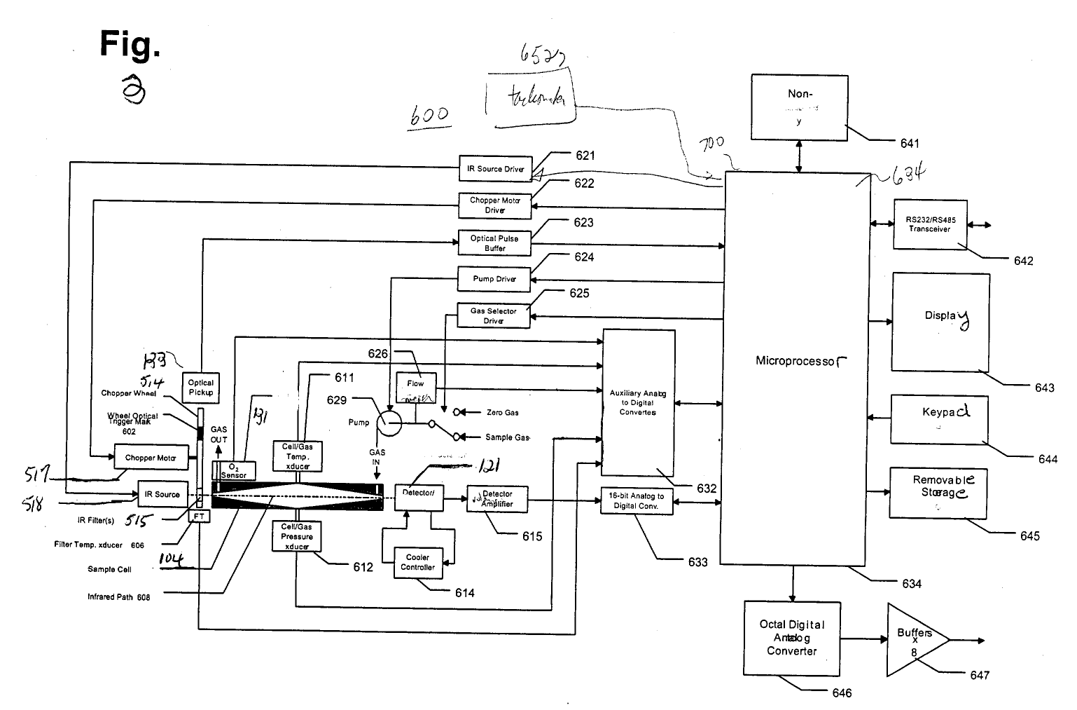

FIG. 1 is a perspective view of hand-held analyzer cell 100 that is used to fabricate a gas analyzer in accordance with one or more embodiments of the present invention. As shown in FIG. 1, analyzer cell 100 includes gas cell 104 that is disposed between detector end module 101 and IR source end module 102. As further shown in FIG. 1, gas cell 104 includes cell/gas pressure port 111 that is connected to pressure transducer 612 (see FIG. 3).

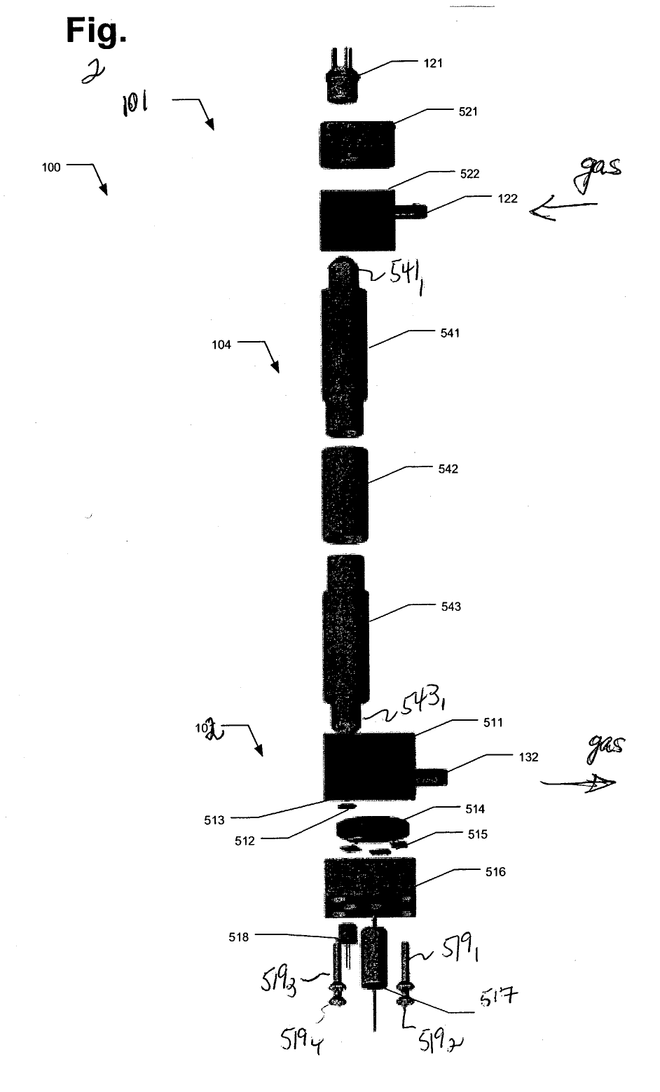

As further shown in FIG. 1, detector end module 101 includes: (a) infrared detector element 121 that is disposed at an outside end of detector end module 101; (b) gas inlet 122 that is disposed at an outside end of detector end module 101; and (c) gas temperature sensing port 123 that is disposed at an outside end of detector end module 101 and is connected to gas temperature sensor 611 (see FIG. 3). As further shown in FIG. 1, IR source end module 102 includes: (a) oxygen cell sensor module 131; (b) gas outlet 132; (c) filter temperature sensing port 136 that is connected to filter temperature sensor 606 (see FIG. 3); (d) chopper motor 517; (e) IR source module 134; and (f) optical pickup module 133 that is used to obtain a position of chopper wheel 514 (see FIG. 2).

FIG. 2 is an exploded view of analyzer cell 100 shown in FIG. 1. As shown in FIG. 2, in accordance with one or more embodiments of the present invention, gas cell 104 (connected between detector end module 101 and IR source end module 102) comprises three sections that are connected to form gas cell 104: (a) cell 542 having a cylindrical inside volume; and (b) cells 541 and 543 that are disposed at opposite ends of cell 542, each of which has an inner volume that is in the form of a truncated cone. In accordance with one embodiment of the present invention, cells 541 and 543 are each made up of a cylindrical tube whose inner diameter has a minimum at a first end and a maximum at a second end wherein the inner diameter is linearly increased from the first end to the second end to provide the truncated cone of the inner volume of the cell (as one can readily appreciate, in such an embodiment, the outside wall of the cell may be any shape). In accordance with one or more further embodiments of the present invention, gas cell 104 can be formed of: (a) one of the above-described cells having a conical inside wall; (b) two of the above-described cells having a conical inside wall wherein the cells are attached to each other with their larger, inner diameters intimately facing each other; or (c) two of the above-described cells having a conical inside wall wherein the cells are each attached to a cell section having an inside wall whose inner diameter is constant and is as large as the larger inner diameter of each of the cells (for example, as is the case for gas cell 104 shown in FIGS. 1 and 2). In accordance with one or more embodiments of the present invention, the inner walls of gas cell 104 are formed of, or coated with, a highly reflective, non-oxide forming, material such as, for example and without limitation, gold. In addition, as further shown in FIG. 2, ends 541, and 543, of cells 541 and 543, respectively, are formed to enable them to be inserted into gas inlet manifold module 522 and gas outlet manifold module 511, respectively.

In accordance with one or more embodiments of the present invention, gas is delivered to, and extracted from gas cell 104 using Radial Discharge technology. In particular, in accordance with such embodiments of the present invention, a series of small holes (not shown) are spaced around ends 541, and 543, of cells 541 and 543, respectively, which holes are directed through the wall of cells 541 and 543 toward a central longitudinal axis of cells 541 and 543 (i.e., the holes are radially disposed). In accordance with one or more of such embodiments, gas is coupled through the holes in end 541₁ into cell 541 and through the holes in end 543₁ out of cell 543 utilizing, for example and without limitation, a banjo type collar (not shown) that is well known to those of ordinary skill. The banjo collars fit over ends 541₁ and 543₁ of cells 541 and 543, respectively, and the banjo collars have holes that are aligned with the holes in ends 541₁ and 543₁ of cells 541 and 543, respectively. Thus, in accordance with one or more such embodiments of the present invention, gas inlet manifold module 522 includes gas inlet 122 that is fixedly coupled to: (a) gas inlet manifold module 522 and (b) the banjo collar utilizing any one of a number of methods that are well known to those of ordinary skill in the art. As a result, in operation, gas flows into gas inlet 122, into the banjo collar, through the holes in the banjo collar, and into end 541, of cell 541 through holes that are aligned with the holes in the banjo collar. End 541₁ of cell 541 may be inserted (for example and without limitation, by a force fit, by a threaded connection, and so forth) into the banjo collar. In accordance with one or more embodiments of the present invention, gas outlet 132, gas outlet manifold module 511, a banjo collar, and end 543₁ of cell 543 are assembled in the same manner as that described above for gas inlet 122, gas inlet manifold module 522, a banjo collar, and end 541₁ of cell 541.

In accordance with the above-described embodiment, the radial inlet of gas into gas cell 104 and the radial extraction of gas from gas cell 104 creates a convergence of gas along a central longitudinal axis of gas cell 104 whose turbulence is beneficial in purging gas cell 104 of gas as well as in uniformly dispersing the gas in gas cell 104. In addition, the multiple radial hole outlet described above advantageously prevents collection of water in gas cell 104 by providing a direct exit at any angle from gas cell 104.

It should be appreciated that further embodiments of the present invention exist wherein: (a) gas cell 104 may be fabricated using a structure having fewer pieces or more pieces than was the case for the structure described above; (b) an inner volume of gas cell 104 has a different shape than was the case for the structure described above; (c) gas cell 104 may be coupled to gas inlet 122 and gas outlet 132 using mechanisms that are different from the mechanism described above; and/or (d) gas inlet manifold module 522 and gas outlet manifold module 511 may be fabricated utilizing alternative construction mechanisms from that described above.

As further shown in FIG. 2, IR source housing module 516 is affixed to gas outlet manifold module 511 utilizing, for example and without limitation, screws 519₁-519₄, and IR source housing module 516 holds: (a) chopper motor 517; (b) chopper wheel 514; and (c) IR (infrared) source 518. In accordance with one or more embodiments of the present invention, chopper motor 517 is configured to cause chopper wheel 514 to rotate, and chopper wheel 514 includes a plurality of filter elements 515. In fabricating a handheld embodiment of the present invention, chopper motor 517 is a micro/miniature motor such as, for example and without limitation, those obtained from JinLong Machinery & Electronics Co., Ltd of China. As further shown in FIG. 2, sealer 513 (for example and without limitation, an o-ring) is inserted into a recess in the end of gas outlet manifold module 511, and radiation window 512 (fabricated, for example and without limitation, from sapphire) is inserted against sealer 513 in the recess. In accordance with one or more such embodiments of the present invention, there is no dead space between an opening at end 543₁ of cell 543 and radiation window 512 (as such, sealer 513 prevents gas from escaping gas cell 104). Thus, in accordance with such an embodiment, gas exits gas cell 104 directly against radiation window 512. Further, IR source 518 and chopper wheel 514 are aligned so that infrared (“IR”) radiation emitted by IR source 518 passes through filters 515 (as they are rotated into the path of the radiation), and the remaining radiation passes through radiation window 512 and enters gas cell 104.

In accordance with one or more embodiments of the present invention, a sealer (not shown) (that is fabricated for example and without limitation, as an o-ring) is inserted into a recess in the end of gas inlet manifold module 522, and a radiation window (not shown) (that is fabricated, for example and without limitation, from sapphire) is inserted against the sealer in the recess. In accordance with one or more such embodiments of the present invention, there is no dead space between an opening at end 541₁ of cell 541 and the radiation window (as such, the sealer prevents gas from escaping gas cell 104). Thus, in accordance with such an embodiment, gas enters gas cell 104 directly against the radiation window. As further shown in FIG. 2, detector housing module 521 is affixed to gas inlet manifold module 522 utilizing, for example and without limitation, screws (not shown), and detector housing module 521 holds infrared detector element 521. As shown in FIG. 2, infrared detector element 121 is aligned so that it detects IR radiation transmitted through gas cell 104 and the radiation window.

As one can readily appreciate from the above, one or more of the above-described embodiments of the present invention provide an unobstructed 360 degree entry of gas into gas cell 104 and exit of gas from gas cell 104. Further, advantageously due to the fact that the gas travels directly across the radiation windows, water vapor collection and deposits on the radiation windows are minimized.

FIG. 3 is a block diagram of gas analyzer 600 that is fabricated in accordance with one or more embodiments of the present invention. As shown in FIG. 3, gas analyzer 600 includes chopper wheel 514 that includes N+1 infrared filters or windows 515, of any shape, that are used in accordance with one or more embodiments of the present invention to obtain information relating to N distinct gases. In accordance with one or more embodiments of the present invention, N+1 infrared filters 515 are located along a constant radius from a center of chopper wheel 514, which constant radius is less than the overall radius of chopper wheel 514. Further, in accordance with one or more such embodiments, chopper wheel 514, in addition to N+1 infrared filters 515, includes an infrared opaque area (not shown) that completely blocks infrared radiation.

As further shown in FIG. 3, chopper motor 517 (fabricated, for example and without limitation, as a miniature chopper motor to enable one to fabricate a hand-held version of gas analyzer 600) causes chopper wheel 514 to rotate utilizing any one of a number of mechanisms that are well known to those of ordinary skill in the art. For example and without limitation, chopper motor 517 may be coupled directly to chopper wheel 514 (in which case chopper wheel 514 will rotate at the same rotational speed as chopper motor 517), or chopper motor 517 may be coupled indirectly to chopper wheel 514 utilizing any one of a number of methods and mechanisms that are well known to those of ordinary skill in the art such as, for example and without limitation, a belt and pulley mechanism, a geared mechanism, a friction coupled mechanism, a magnetically coupled mechanism, or any other mechanism that will allow rotational torque to be transferred from chopper motor 517 to chopper wheel 514. Further, chopper motor 517 may be any type of motor such as, for example and without limitation, a brushed DC motor, a brush-less DC motor, an induction motor, a synchronous motor, any type of reluctance motor, a stepper motor, or any type of device that produces rotation. As further shown in FIG. 3, chopper motor 517 is driven in response to signals received from chopper motor driver 622, which chopper motor driver 622 is driven in turn by signals received from microprocessor 634 of processor module 700. Chopper motor driver 622 may be fabricated utilizing any one of a number of such devices that are well known those of ordinary skill in the art, and chopper motor driver 622 may be driven by microprocessor 634 of processor module 700 utilizing any one of a number of methods that are well known to those of ordinary skill in the art.

As further shown in FIG. 3, gas analyzer 600 includes optical pickup 133 and chopper wheel 514 further includes wheel optical trigger mark 602. Optical pickup 133 is disposed in IR source housing module 516 in a position configured for it to detect wheel optical trigger mark 602. In accordance with one or more embodiments of the present invention, wheel optical trigger mark 602 is an aperture placed anywhere on chopper wheel 514 that passes radiation output by a radiation emitting device (not shown, which is located, for example and without limitation, in optical pickup 133) to a radiation detecting device (not shown, which is located, for example and without limitation, in optical pickup 133). For example and without limitation, the radiation emitting device and the radiation detecting device may be located on opposite sides of chopper wheel 517. In accordance with an alternative embodiment, an area of the surface of chopper wheel 514 can be made to have adequate contrast for radiation emitted by the radiation emitting device so that it reflects with varying intensity. In such a case, a radiation detecting device placed near the radiation emitting device can receive the reflected radiation having varying intensity and produce a signal in response thereto, which radiation emitting device and which radiation detecting device may be disposed on the same side of chopper wheel 514. In either case, the radiation emitting device and the radiation detecting device may be fabricated using any one of a number of such devices that are well known to those of ordinary skill in the art. Further, in either case, optical pickup 133, generates a signal that is transmitted to optical pulse buffer 623, and a digital representation of that signal is applied as input to microprocessor 634 of processor module 700 in accordance with any one of a number of methods that are well known to those of ordinary skill in the art. Optical pulse buffer 623 may be fabricated utilizing any one of a number of such devices that are well known to those of ordinary skill in the art.

Microprocessor 634 of processor module 700 utilizes the signal from optical pulse buffer 623 to detect a position of chopper wheel 514 once per revolution of chopper wheel 514, and thereby the location of each of infrared filters 515 in accordance with any one of a number of methods that are well known to those of ordinary skill in the art. As one can readily appreciate, further embodiments of the present invention exist wherein a triggering mechanism that outputs a signal that is used to determine the location of each of infrared filters 515 can be fabricated utilizing any one of a number of non-contact triggering mechanisms that are well known to those of ordinary skill in the art such as, for example and without limitation, a trigger mechanism comprising a permanent magnet that is located on chopper wheel 514 and a magnetic field sensor such as, for example and without limitation, a Hall device, that is placed in sufficiently close proximity to chopper wheel 514 that it can sense a variation in the magnetic field as the permanent magnet passes by the sensor.

In accordance with one or more embodiments of the present invention, microprocessor 634 of processor module 700 interprets the “trigger signal” that indicates detection of wheel optical trigger mark 602 as a location corresponding to zero degrees of rotation of chopper wheel 514. Microprocessor 634 uses the time between the last two trigger signals to determine a time period that corresponds to one revolution of chopper wheel 514, which time is designated To. As such, To corresponds to a time interval during which chopper wheel 514 rotates by 360 degrees, and T₀/360 corresponds to a time interval during which chopper wheel 514 rotates by one degree. Using this time interval (T₀/360) and the known position of each side of each of infrared filters 515 in degrees from the location corresponding to zero degrees, microprocessor 634 converts the locations of each side of each of infrared filters 515 and the opaque area to time intervals from the trigger signal. In other words, microprocessor 634 computes t₀ and t₂ (for example and without limitation, in units of T₀/360) for each filter and the opaque area where: (a) t₁ is the amount of time after the trigger signal is received at which the first side of the filter is in front of radiation output from IR source 518; and (b) t₂ is the amount of time after the trigger signal is received at which the second side of the filter is in front of radiation output from IR source 518.

In accordance with one or more embodiments of the present invention, IR source 518 emits infrared radiation and has a native or synthesized aperture that is less than a width of each of infrared filters 515. In accordance with one or more such embodiments of the present invention, IR source 518 has a wavelength spectrum in a range, for example and without limitation, from about 2 μm to about 20 μm. Such infrared sources are well known to those of ordinary skill in the art, and are available commercially. Such a wavelength spectrum ensures that a number of gases such as, for example and without limitation, hydrocarbons (“HC”), carbon monoxide (“CO”), carbon dioxide (“CO₂”), oxygen (“O₂”), and nitrogen oxide (“NOₓ”) absorb energy at wavelengths within the specified range. As shown in FIG. 3, process module 700 sends a signal to IR source driver 621, and IR source driver 621, in turn, sends a signal to IR source 518 to cause it to emit infrared radiation. IR source driver 621 may be fabricated utilizing any one of a number of such devices that are well known to those of ordinary skill in the art.

In accordance with one or more such embodiments, each gas whose concentration is to be determined has a corresponding narrow bandwidth, band-pass filter associated with it that is placed on rotating chopper wheel 514 so that the filter is periodically placed after IR source 518 and before gas cell 104 and detector element 121. In addition, in accordance with one or more embodiments of the present invention, a reference filter is placed on rotating chopper wheel 514 to measure the maximum IR radiation energy available from IR source 518 and measured by detector element 121 that does not depend on the concentrations of the constituents to be analyzed, which reference filter is a narrow bandwidth, band-pass filter having a center band-pass wavelength and band-pass width such that none of the gases to be analyzed absorbs energy transmitted by the reference filter band-pass (as such, the energy measured by detector element 121 for IR radiation passing through the reference filter will not be effected by changes in concentrations of constituents of the gas introduced into gas cell 104). Such infrared filters and the reference filter are well known to those of ordinary skill in the art, and are available commercially. Lastly an opaque area is placed on rotating chopper wheel 514 to measure the minimum energy measured by detector element 121. Thus, upon one revolution of chopper wheel 514, IR radiation will be blocked by one opaque area, passed through one reference window, and passed through a filter designed for each of the gases whose concentrations are to be determined.

In particular, infrared radiation output from IR source 518 passes through N+1 filters 515 as each is brought into alignment when chopper motor 517 causes chopper wheel 514 to rotate. After passing through one of filters 515, the remaining infrared radiation passes through radiation window 512 in analyzer cell 100, and passes through gas cell 104 (path 608 shown in FIG. 3) where various concentrations of gas(es) absorb varying amounts of the remaining infrared radiation. Next, the resulting infrared radiation passes through a radiation window in IR detection end module 101, and reaches infrared detector element 121, for example, a fast responding infrared detector. As described above, and in accordance with one or more embodiments of the present invention, IR source 518 outputs infrared radiation having a wavelength spectrum that is broad enough so that it envelops at least predetermined portions of the infrared absorption spectrum of the N gases that can be used to identify all N gases.

In order for infrared detector element 121 to observe a steady infrared radiation signal as chopper wheel 514 places one of infrared filters 515 in front of IR source 518 as the one of infrared filters 515 is rotated, an output aperture of IR source 518 ought to be less than an arc length across any of infrared filters 515, which arc length is measured at a radius corresponding to a distance from the center of chopper wheel 514 to about an average of the center of infrared filters 515. In accordance with one or more embodiments, this is achieved by selecting a source having a very small aperture (i.e., essentially a point source) or by fabricating an aperture whose diameter is less than an arc length of any of infrared filters 515.

Infrared detector element 121 determines a measure of the energy of the infrared radiation impinging thereon, and in accordance with one or more embodiments of the present invention, infrared detector element 121 must have a response time that is sufficiently fast that it can accurately measure the rapid variation in energy of the radiation output from IR source 518 caused by movement of infrared filters 515. In accordance with one or embodiments of the present invention, infrared detector element 121 is embodied utilizing a device whose resistance changes as varying amounts of infrared energy are detected. In accordance with one or more such embodiments, a constant current source (not shown) having a precision, for example and without limitation, of about ±2% drives a constant current into infrared detector element 121 in response to a signal (not shown) from microprocessor 634 of processor module 700. In further accordance with one or more such embodiments, (a) the resistance of infrared detector element 121 is at a maximum value with no incident infrared radiation energy and at a minimum value with maximum incident infrared energy; and (b) the variation in resistance is linearly proportional to incident radiation energy. As a result, the use of a constant current source produces a voltage across infrared detector element 121 that is inversely proportional to the energy of infrared radiation incident upon its surface. The current source may be fabricated utilizing any one of a number of such devices that are well known to those of ordinary skill in the art. In accordance with one or more embodiments of the present invention, infrared detector element 121 is a lead selenide (PbSe), thermoelectrically cooled detector that is commercially available. Further, as shown in FIG. 3, in accordance with such an embodiment, cooler controller 614 is used to thermoelectrically cool infrared detector element 121 in response to a signal (not shown) from microprocessor 634 of processor module 700. An advantage of using a current source in the manner described above is that its Thevenin or equivalent impedance can be in hundreds of M ohms, i.e., it is high enough that it will not affect the resistance of infrared detector element 121 itself. Another advantage of using such a current source is that it does not require high voltages to operate a typical embodiment of such an infrared detector element 121 and its series “load” resistance is typically equal to the dark resistance of such an infrared detector element 121.

As further shown in FIG. 3, voltage amplifier 615 having sufficiently high input impedance, for example and without limitation, above about 1M ohm, detects the voltage across infrared detector element 121, and amplifies and filters it so that a difference between the highest and lowest voltage is near the analog input range of analog to digital converter 633, typically 0-5 VDC. The amplified voltage is applied as input to analog-to-digital converter 633. In response, analog-to-digital converter 633 converts the input analog signal into a digital signal. In response to a signal from microprocessor 634, analog-to-digital converter 633 applies the digital signal as input to microprocessor 634 of processor module 700. Voltage amplifier 615 may be fabricated utilizing any one of a number of such devices that are well known to those of ordinary skill in the art, and analog-to-digital converter 633 may be fabricated utilizing any one of a number of such devices that are well known to those of ordinary skill in the art.

Since, as was described above, the relative angle at which sides of each one of filters 515 and the opaque area are disposed relative to the angle of wheel optical trigger mark 602 (taken, for example and without limitation, as zero degrees) are known, microprocessor 634 obtains measurements from detector element 121 at times when IR radiation impinges upon the filters 515 and the opaque area. As will be described in detail below, these measurements are utilized to determine the concentrations of the gases. In accordance with one or more embodiments of the present invention, to provide raw measurement values, microprocessor 634 obtains a number of measurements, for example and without limitation, 16 measurements, from detector element 121 as each one of filters 515 and the opaque area is rotated in front of the IR radiation. Then, in accordance with one or more embodiments of the present invention, this data is filtered to produce a raw measurement. For example and without limitation, for each one of filters 515 and the opaque area, the first 20% of the measurements obtained during the current rotation of chopper wheel 514 are averaged with the last 80% of the measurements obtained during the previous rotation of chopper wheel 514. In accordance with one or more such embodiments, the amount of data used from the current revolution and the amount of data from the previous revolution may be varied, for example and without limitation, in response to user input. Further, in accordance with one or more still further embodiments, the raw data measurements may be filtered utilizing any one of a number of methods that are well known to those of ordinary skill in the art.

As further shown in FIG. 3, gas analyzer 600 includes pressure transducer 612 and temperature measuring device 611, and as shown in FIG. 3, analog signals output from pressure transducer 612 and temperature measuring device 611 are applied as input to auxiliary analog-to-digital converter 632. In response, analog-to-digital converter 632 converts the input analog signals into digital signals. In response to a signal from microprocessor 634, analog-to-digital converter 632 applies the digital signals as input to microprocessor 634 of processor module 700. Microprocessor 634 of processor module 700 uses these signals to measure the temperature and pressure of gas in gas cell 104, which temperature and pressure are utilized to correct for density changes in the gas due to changes in temperature and pressure in accordance with any one of a number of methods that are well known to those of ordinary skill in the art. This density correction is used to convert the gas concentration to that of the controlled conditions of temperature and pressure utilized during calibration in accordance with any one of a number of methods that are well known to those of ordinary skill in the art. Pressure transducer 612 and temperature measuring device 611 may be fabricated utilizing any one of a number of such devices that are well known to those of ordinary skill in the art.

As shown in FIG. 3, pneumatic pump 629 is connected to gas inlet 122, and pneumatic pump 629 pumps gas from a user determined origin, for example, a sample gas, into gas cell 104. Then, infrared radiation output from IR source 518 (after being filtered by one or more of filters 515) is absorbed in gas cell 104 to provide infrared radiation having energy that depends upon the concentrations of particular constituents of the gas pumped into gas cell 104. In accordance with one or more embodiments of the present invention, pump 629 provides a steady flow of gas into gas cell 104 to cause sampled gases to be moved therethrough so that variations in unknown gas concentrations can be measured quickly. As further shown in FIG. 3, pump 629 is driven in response to signals received from pump driver 624, which pump driver 624 is driven in turn by signals received from microprocessor 634 of processor module 700. Pump driver 624 may be fabricated utilizing any one of a number of such devices that are well known those of ordinary skill in the art, and pump driver 624 may be driven by microprocessor 634 of processor module 700 utilizing any one of a number of methods that are well known to those of ordinary skill in the art. Pump 629 may be fabricated utilizing any one of a number of such devices that are well known to those of ordinary skill in the art.

As further shown in FIG. 3, flow meter 626 is used to obtain a measure of gas flow into pump 629. If flow into pump 629 is restricted, gas does not enter gas cell 104 and gas concentrations in the gas cannot be measured or the measurements may be incorrect. In accordance with one or more embodiments of the present invention, flow meter 626 is a gage pressure transducer that is placed, as shown in FIG. 3, at the inlet of pump 629. As further shown in FIG. 3, analog signals output from flow meter 626 are converted to positive voltages that are amplified, conditioned, and applied as input to auxiliary analog-to-digital converter 632. In response, analog-to-digital converter 632 converts the input analog signals into digital signals. In response to a signal from microprocessor 634, analog-to-digital converter 632 applies the digital signals as input to microprocessor 634 of processor module 700. Microprocessor 634 of processor module 700 uses these signals to measure gas pressure at the inlet to pump 629. If there is a restriction at the inlet of pump 629, the gage pressure measured will decrease due to a vacuum created at the inlet, for example, to a value less than atmospheric pressure. In accordance with one embodiment of the present invention, microprocessor 634 treats a pressure value less than a predetermined value to be a blocked inlet, and provides a flow restriction warning. For example, in accordance with one such embodiment of the present invention, microprocessor 634 transmits information to optional display device 643 to cause an appropriate warning such as a blinking signal to be displayed. Flow meter 626 may be fabricated utilizing any one of a number of such devices that are well known to those of ordinary skill in the art.

As further shown in FIG. 3, gas analyzer 600 includes chopper wheel/infrared filter temperature 606. Output analog signals from chopper wheel/infrared filter temperature 606 are applied as input to auxiliary analog-to-digital converter 632. In response, analog-to-digital converter 632 converts the input analog signals into digital signals. In response to a signal from microprocessor 634, analog-to-digital converter 632 applies the digital signals as input to microprocessor 634 of processor module 700. Microprocessor 634 of processor module 700 uses these signals to measure the temperature of chopper wheel 514. In an embodiment wherein filter characteristics vary as a function of temperature, the temperature of chopper wheel 514 may be utilized in accordance with any one of a number of methods that are well known to those of ordinary skill in the art to provide corrections which are a function of temperature. Lastly, microprocessor 634 includes a module (not shown) to measure system voltage to enable it to provide an indication such as, for example and without limitation, an alarm in accordance with any one of a number of methods that are well known to those of ordinary skill in the art in case an interruption in power is detected.

As shown in FIG. 3, gas that exits gas cell 104 flows through oxygen cell sensor module 131 that detects the presence of oxygen (“O₂”). A suitable oxygen cell sensor module is available from Electrovac GmbH, an Austrian company. According to Electrovac (the oxygen sensor is based on an electrochemical pumping cell made of Zirconium), the principle of operation is as follows: “When voltage is applied to this cell, oxygen ions are pumped through the cell from the cathode to the anode side. By attaching a cap with a pinhole on the cathode side of the cell the current shows saturation due to the rate-limiting step in the transfer to the cathode. This limiting current is nearly proportional to the ambient oxygen concentration.” Thus, the gas stream will produce a current given a constant voltage excitation, which current is proportional to the oxygen concentration. In accordance with this embodiment of the present invention, a trans-impedance (current to voltage) amplifier is used to measure the current produced by oxygen cell sensor module 131 when it is being excited by a constant voltage, and to convert this current into a voltage level suitable for input to an analog-to-digital converter. As such, the output from the amplifier is applied as input to auxiliary analog-to-digital converter 632. In response, analog-to-digital converter 632 converts the input analog signal into a digital signal. In response to a signal from microprocessor 634, analog-to-digital converter 632 applies the digital signal as input to microprocessor 634 of processor module 700. In accordance with one or more embodiments of the present invention, microprocessor 634 transmits information to optional display device 643 to cause the oxygen concentration to be displayed thereon. Alternatively, or in addition, microprocessor 634 may store the oxygen concentration in non-volatile storage 641 and/or on removable storage 645 (to enable future access to any data collected using a computer). Alternatively, or in addition, microprocessor 634 may transmit the oxygen concentration to other devices using transmitter 642 or equipment 646 and 647. Such options may be input to microprocessor 634 using, for example, and without limitation, keypad 644 utilizing a human interface that may be fabricated utilizing any one of a number of methods that are well known to those of ordinary skill in the art. As such, one or more embodiments of the present invention can provide oxygen concentrations using non-infrared based means with response times comparable to the infrared based concentrations in any output format and in update intervals of less than half of a second. For example, the output can be provided to a user, for example and without limitation, through a display, wired or wireless analog voltage, or wired or wireless binary communication. It should be understood that further embodiments of the present invention exist where oxygen cell sensor module 131 may be any one of a number of oxygen chemical sensor cells that are commercially available from a number of sources.

Tachometer 652 is a device used to measure revolutions per minute (“RPM”) of crankshaft rotation or engine speed. For example, tachometer 652 may measure the rotational rate of a combustion engine by utilizing an inductive pickup that is placed over a spark plug wire. As is well known, the inductive pickup acts as a transformer to produce an EMF or voltage every time the selected spark plug fires (this occurs every other revolution in a four-stroke engine, or every revolution in a two-stroke engine). The voltage will be in the form of a pulse having a relatively short pulse width, and this pulse is amplified and used to trigger a monostable or one-shot trigger. For example, in accordance with one or more embodiments of the present invention, the monostable trigger will increase the trigger pulse width to a predetermined value. In accordance with one or more alternative such embodiments, the inductive pickup may be placed near the main ignition coil. In accordance with one or more further alternative embodiments, tachometer 652 directly senses the alternating current ripple produced by either the ignition system or the alternator/generator used to charge an on-board vehicle battery in accordance with any one of a number of methods that are well known to those of ordinary skill in the art. In any event, as shown in FIG. 3, tachometer 652 outputs a pulse that is applied as input to microprocessor 634. In response, microprocessor 634 counts the time between pulses in accordance with any one of a number of methods that are well known to those of ordinary skill in the art, and derives the RPM value. Tachometer 652 may be fabricated utilizing any one of a number of such devices that are well known to those of ordinary skill in the art. As such, microprocessor 634 measures the rotational speed of a combustion engine, for example and without limitation, in revolutions per minute (“RPM”). In accordance with one or more embodiments of the present invention, microprocessor 634 transmits information to optional display device 643 to cause the RPM measurement to be displayed. Alternatively, or in addition, microprocessor 634 may store the RPM measurement in non-volatile storage 641 and/or on removable storage 645 (to enable future access to any data collected using a computer). Alternatively, or in addition, microprocessor 634 may transmit the RPM measurement to other devices using transmitter 642 or equipment 646 and 647. Such options may be input to microprocessor 634 using, for example, and without limitation, keypad 644 utilizing a human interface that may be fabricated utilizing any one of a number of methods that are well known to those of ordinary skill in the art. For example, the output can be provided to a user, for example and without limitation, through a display, wired or wireless analog voltage, or wired or wireless binary communication. In addition, the oxygen concentration measurements described above may be provided in all of the above-described methods to further include a correlation of the rotational speed and the oxygen concentrations.

As shown in FIG. 3, processor module 700 of gas analyzer 600 includes non-volatile memory 641 (for example and without limitation, one or more modules) that is connected to microprocessor 634 in accordance with any one of a number of methods that are well known to those of ordinary skill in the art. Non-volatile memory 641 is used to store operating parameters such as, for example and without limitation, calibration curve constants (to be described below); user preferences such as, for example and without limitation, configuration information, number of gases to be analyzed, display formats, data to store, and the like; adjustable parameters such as, for example and without limitation, the number of filters on chopper wheel 514, and the like; any dynamic values that need to be preserved; and to store data in accordance with user-specified requests. In accordance with one or more further embodiments of the present invention, complimentary devices such as, for example and without limitation, storage devices or data analyzers, data display devices, and so forth may be attached to or used in conjunction with gas analyzer 600 to attain or enhance information being taken thereby in accordance with any one of a number of methods that are well known to those of ordinary skill in the art. For example, optional display 643 may be used to provide measurement outputs and to provide a user interface in accordance with any one of a number of methods that are well known to those of ordinary skill in the art; optional keypad 644 may be is used to receive user input, for example and without limitation, to set user preferences, to make user requests and so forth in accordance with any one of a number of methods that are well known to those of ordinary skill in the art; RS232 transceiver 642 is used to transmit and receive information from remote devices to perform functions such as, for example and without limitation, data acquisition, data storage, data display, and/or data analysis functions in accordance with any one of a number of methods that are well known to those of ordinary skill in the art; and octal digital-to-analog converter 646 and buffers 647 are used to transmit signals to devices such as, for example and without limitation, analog devices to perform functions such as, for example and without limitation, data acquisition, data storage, data display, and/or data analysis functions in accordance with any one of a number of methods that are well known to those of ordinary skill in the art. Lastly, as shown in FIG. 3, processor module 700 of gas analyzer 600 includes removable storage 645 that is connected to microprocessor 634 in accordance with any one of a number of methods that are well known to those of ordinary skill in the art. Removable storage 645 is used mainly for storage of data that can be transferred manually for use (for example and without limitation, analysis) of stored data such as measurements made utilizing gas analyzer 600. It should be understood that processing module 700, as has been explained above, may include at least some form of computer readable media, which computer readable media can be any available media such as, for example and without limitation, computer storage media including volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by microprocessor 634. Further, it should be understood that processing module 700, as has been explained above, may include at least some form of communication media such as, for example and without limitation, that embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As further shown in FIG. 3, gas selector driver 625 is driven in response to a selector signal applied as input from microprocessor 634 to activate a gas selector (not shown). In accordance with one or more embodiments of the present invention, gas selector is a switch, for example and without limitation, a solenoid-activated switch, that causes pump 629 to retrieve “zero” gas (i.e., a gas utilized to calibrate gas analyzer 600 in a manner to be described in detail below) or to retrieve “sample” gas (a gas whose constituents are to be analyzed). Microprocessor 634 generates the selector signal in response to user input provided, for example and without limitation, from keypad 644.

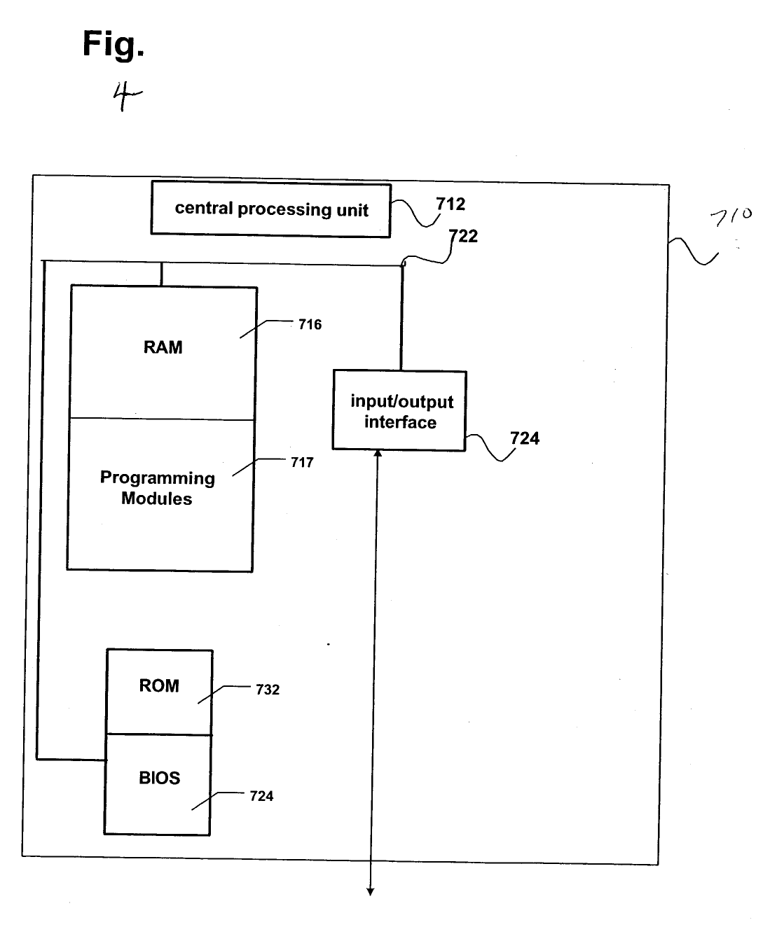

As will be readily appreciated, when gas analyzer 600 is embodied as a portable device, it may not include peripheral devices that might otherwise be present in a general purpose processing system such as, for example and without limitation, a personal computer. However, alternate embodiments of the present invention may include any processing system. For example, other computing systems, environments, and/or configurations that may be suitable for use in fabricating one or more embodiments of the present invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like. One such example includes processing system 710 shown in FIG. 4. As shown in FIG. 4, processing system 710 includes: (a) central processing unit 712; (b) a system memory that includes read only memory (“ROM”) 732 and random access memory (“RAM”) 716; and (c) system bus 722 that couples various system components including the system memory to processor unit 700. System bus 722 may be any of several types of bus structures including a memory bus or memory controller, a peripheral bus and a local bus using any of a variety of bus architectures. As shown in FIG. 4, a basic input/output interface (“BIOS”) which contains basic routines that help transfer information between elements within processing system 710 is stored in ROM 732. Additional mass storage devices, and similar memory/data storage modules (not shown), in addition to ROM 732 may be present to provide data storage for computer executable program modules and programs as needed. A number of program modules may be stored on various mass storage devices, ROM 732 or RAM 716. Generally, program modules include routines, programs, objects, components, data structures, and so forth that perform particular tasks or implement particular abstract data types. Typically the functionality of the program modules may be combined or distributed as desired in various embodiments. One exemplary function of a program module or an application module according to one embodiment of the present invention includes performing a self-test or safety monitoring functions in accordance with any one of a number of methods that are well known to those of ordinary skill in the art. It can be appreciated by one skilled in the art that there are a multitude of different, more or less complex, configurations of a general purpose computing system that may have an embodiment of the present invention embedded within it, such that it need not be shown or discussed herein. Data capture is a method or library of past readings of information taken by the gas analyzer and stored for later evaluation or simulation. As such data capture stores any processed data including, for example and without limitation, all N gas concentrations, oxygen concentration, external values from Add-On devices including but not limited to GPS data for calculating velocity, altitude, and course outline; and accelerometer values. These data may be used to provide correlations between, for example and without limitation, gas concentrations and/or oxygen concentrations correlated as a function of time (for example and without limitation, during particular driving conditions); as a function of particular driving conditions which may be indicated by correlation with GPS data for velocity, altitude and course outline (for example and without limitation, correlation with map information); as a function of driving conditions such as acceleration indicated as a function of accelerometer values, and so forth.

In accordance with one or more embodiments of the present invention, all of the above-described components of gas analyzer 600 are functionally interconnected and controlled by processing modules residing on processor module 700, which processing modules are executed by microprocessor 634.

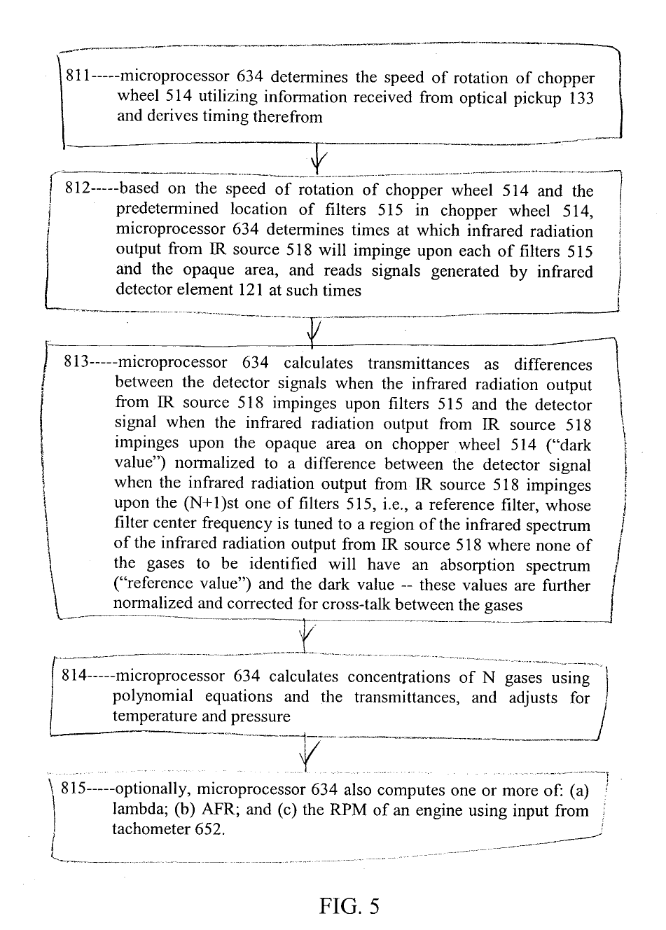

In accordance with one or more embodiments of the present invention, gas analyzer 600 determines concentrations of gases contained in gas flowing through gas cell 104 using the following method which is illustrated in FIG. 5. First, as shown in step 811 of FIG. 5, microprocessor 634 (executing one or more program modules in a manner that is readily understood by those of ordinary skill in the art) determines the speed of rotation of chopper wheel 514 utilizing information received from optical pickup 133 (for example, in the form of pulses) and derives timing therefrom. Next, as shown in step 812 of FIG. 5, based on the speed of rotation of chopper wheel 514 and the predetermined location of filters 515 in chopper wheel 514, microprocessor 634 (executing one or more program modules in a manner that is readily understood by those of ordinary skill in the art) determines times at which infrared radiation output from IR source 518 will impinge upon each of filters 515 and the opaque area, and reads signals generated by infrared detector element 121 at such times. Next, as shown in step 813 of FIG. 5, microprocessor 634 (executing one or more program modules in a manner that is readily understood by those of ordinary skill in the art) calculates transmittances as a difference between values of the detector signal (for example and without limitation, averages as described above) at times the infrared radiation output from IR source 518 impinges upon filters 515 on chopper wheel 514 and a value of the detector signal (for example and without limitation, averages as described above) at the time the infrared radiation output from IR source 518 impinges upon the opaque area on chopper wheel 514 (“dark value”). Microprocessor 634 (executing one or more program modules in a manner that is readily understood by those of ordinary skill in the art) normalizes these transmittances to a difference between the value of the detector signal (for example and without limitation, averages as described above) at the time the infrared radiation output from IR source 518 impinges upon the (N+1)^{st} one of filters 515, i.e., a reference filter, whose filter center frequency is tuned to a region of the infrared spectrum of the infrared radiation output from IR source 518 where none of the gases to be identified will have an absorption spectrum (“reference value”) and the dark value. These values are further normalized and corrected for cross-talk between the gases in a manner that is described in detail below. Next, as shown in step 814 of FIG. 5, microprocessor 634 (executing one or more program modules in a manner that is readily understood by those of ordinary skill in the art) calculates concentrations of N gases using polynomial equations and the transmittances in a manner that is described in detail below, and adjusts for temperature and pressure in a manner that is described in detail below.

Lastly, as shown in step 815 of FIG. 5, optionally, in addition to computing the gas concentrations, microprocessor 634 (executing one or more program modules in a manner that is readily understood by those of ordinary skill in the art) computes one or more of: (a) lambda (as is well known, lambda is a stoichiometric or ideal air-fuel ratio that provides a complete combustion normalized to value of 1.0) in a manner that is described in detail below; (b) air-fuel ratio (AFR) (as is well known, AFR is a ratio of the concentration of oxygen to the concentration of hydrocarbons, i.e., AFR=lambda*14.6; and (c) the RPM of an engine using input from tachometer 652 (in a manner that was described above). In accordance with one or more embodiments of the present invention, all results, including correlations of such results with the RPM measurements, and/or oxygen concentration, are displayed on optional display 643 in any one of a number of formats that are provided in accordance with any one of a number of methods that are well known to those of ordinary skill in the art, and all results, may be optionally communicated to a host system (not shown) via RS232 serial interface 642, which interface may optionally be a wireless transmission interface in accordance with any one of a number of methods that are well known to those of ordinary skill in the art. Display 643 and serial interface 642 may be fabricated utilizing any one of a number of such devices that are well known to those of ordinary skill in the art.

The following describes an embodiment of gas analyzer 600 that determines the concentrations of HC, CO, and CO₂. First, measurements made by detector element 121 are applied as input to microprocessor 634 by analog-to-digital converter 633 (ADC 633) and filtered as described above to provide raw values: C_{ref} (a raw value that is obtained with the reference filter in position); C_{dark} (a raw value that is obtained with the opaque area in position); C^{HC} (a raw value that is obtained with the hydrocarbon filter in position); C_{CO} (a raw value that is obtained with the carbon monoxide filter in position); and C_{CO2} (a raw value that is obtained with the carbon dioxide filter in position) In accordance with one or more embodiments of the present invention, these raw values are expressed in terms of counts out of a possible 2\hat{ }bits counts, where bits represents the resolution of ADC 633 shown in FIG. 3.

Using these raw values, the following values are determined, which values provide a measure of energy (i.e., a measure of infrared energy that passed through the gas mixture for each of the gases and the reference) and which values are also expressed in terms of counts out of a possible 2\hat{ }bits counts. These values are determined by subtracting the raw value for the dark or opaque area from the raw value for each filter: E_{reference}=C_{reference}−C_{dark}, E_{HC}=C_{HC}−C_{dark}, E_{CO}=C_{CO}−C_{dark}, and E_{CO2}=C_{CO2}−C_{dark}.

Next, transmittance values are determined. Transmittance is the amount of energy transmitted through the gas normalized to 1. The normalization is done against the value for the reference. Thus, a transmittance value of 1 means that all of the energy (100%) output from IR source 518 reached detector element 121, and none was absorbed by the gas. (HC transmittance) T_{HC}=E_{HC}/E_{reference}, (CO transmittance) T_{CO}=E_{CO}/E_{reference}, and (CO₂ transmittance) T_{CO2}=E_{CO2}/E_{reference}.

Because of factors such as filter construction, source temperature, and other uncontrolled parameters, a gas will have a transmittance value that is not exactly 1 even if that gas is 100% of the gas in gas cell 104. In order to normalize the transmittances to 1, in accordance with one or more embodiments of the present invention, gas analyzer 600 is “zeroed.” The process of “zeroing” gas analyzer 600 comprises purging gas cell 104 with a gas that does not contain any of the gases whose concentration is to be determined (as set forth above, microprocessor 634 sends a signal that is applied as input to gas selector driver 625 and, in turn, gas selector driver 625 sends a signal to a gas selector switch to cause pump 629 to draw gas from the “zero” outlet shown in FIG. 3). For example and without limitation, nitrogen may be used for this purpose. Once gas cell 104 is purged, a transmittance value is recorded and stored, for example and without limitation, in memory 641 for each of the filters. These “zero” values are then used to normalize the transmittances to 1 as follows. (HC normalized transmittance) TZ_{HC}=T_{HC}/T_{HC(zero)}, (CO normalized transmittance) TZ_{CO}=T_{CO}/T_{CO(zero)}, and (CO₂ normalized transmittance) TZ_{CO2}=T_{CO2}/T_{CO2(zero)}.

Next, the transmittances are corrected for cross-talk. Ideally, filters 515 are designed so that IR radiation transmitted by the passband of one filter will only be absorbed by one gas and not any others. In practice however, cross-talk occurs where IR radiation transmitted by one filter will be absorbed by more than one gas. As a result, a correction must be made to account for this effect. Such a correction is made as follows. TZ_{HC}=C_{xtalkHC-CO}*T_{CO}+C_{xtalkHC-CO2}*T_{CO2}; TZ_{CO2}=C_{xtalkC}_{O2-HC}*T_{HC}+C_{xtalkCO2-CO}*T_{CO}; and TZ_{CO}=C_{xtalkCO-HC}*T_{HC}+C_{xtalkCO-CO2}*T_{CO2}; where C_{xtalkHC-CO}; C_{xtalkHC-CO2}; C_{xtalkCO2-HC}; C_{xtalkCO2-CO}; C_{xtalkCO-HC}; and C_{xtalkCO-CO2} are cross-talk coefficients that are determined by calibration using gases having known concentrations of constituents in accordance with any one of a number of methods that are well known to those of ordinary skill in the art.

Next, concentrations of each gas are determined utilizing polynomial coefficients stored during calibration (as described below).

Next, the concentrations determined above are corrected using Boyle's law to account for the fact that the temperature and pressure of gas in gas cell 104 is different from the temperature and pressure of gas in gas cell 104 during calibration of gas analyzer 600. For example, in accordance with one or more embodiments of the present invention, the following correction is made, for example, for HC.

C_{HCcorrected}=C_{HC}* [(Tₘₑₐₛ+273)/T_{calb}+273)]^{γ}*[P_{calb}/Pₘₑₐₛ]^{β}

where: Tₘₑₐₛ and T_{calb} are the temperatures during the measurement and calibration, respectively; Pₘₑₐₛ and P_{calb} are the pressures during the measurement and calibration, respectively; and γ and β are constants that are determined in accordance with any one of a number of methods that are well known to those of ordinary skill in the art.

Next, in the last step of determining the concentration, the concentrations are multiplied by a multiplicative factor or “span” that is determined during field calibration (as described below).

As one can readily appreciate, the normalized transmittance for a particular type of gas, in the absence of that gas will always be 1. Further, the presence of a particular gas in gas cell 104 will reduce the transmittance value from 1 based on an amount that depends on the concentration of the particular gas. However, the reduction in transmittance level for a given concentration of the particular gas can also vary from one gas analyzer to another depending on the length of gas cell 104, the center frequency of the infrared filters, and the temperature of IR source 518 for the particular embodiment. Given these variations, it may be difficult to predict, with acceptable accuracy, the concentration of each gas. As a result, and in accordance with one or more embodiments of the present invention, a calibration process is used to mitigate these variations by providing information relevant to each particular gas analyzer. This is sometimes referred to as a “factory” calibration process. The factory calibration process is carried out as follows in accordance with one or more embodiments of the present invention. First, pressure transducer 612 is calibrated by: (a) taking a reading of voltage output by pressure transducer 612 at known values of high and low pressure; (b) calculating an offset and slope of a line defined by these two pressure points; and (c) storing the offset and slope in memory, for example and without limitation, non-volatile RAM 641, that is accessible by microprocessor 634. Next, transmittance values are obtained for each of filters 515 using, for example and without limitation, N₂ (this is referred to above as “zeroing” the gas analyzer). Next, measured values of transmittance are obtained at predetermined values of concentration (for example, at 0, 10, 20, 30, 40, 50, 60, 70, 80, 90, 100 percent) for a number of gases certified to have specified concentrations of specified gases (for example, Hexane (only take one sample point at 100%), Low Propane, Hi Propane, Low CO, High CO, and CO₂). For example, Low CO refers to a specific certified gas having a predetermined low concentration of CO (for example, 1%) and High CO refers to a specific certified gas having a predetermined high concentration of CO (for example, 10%). Thus, for example, in the case of Low CO, measured values of transmittance are obtained at 0, 10, 20, 30, 40, 50, 60, 70, 80, 90, 100 percent of the predetermined low concentration. Next, a best-fit equation is generated to represent the concentration of a particular gas as a polynomial function of normalized transmittance where the best-fit equation has the form C(T)=A0+A1*T+A2*T\hat{ }2+A3*T\hat{ }3+ . . . ; where An represents coefficients derived from a best-fit, T is the normalized transmittance, and C(T) is the concentration of the particular gas at the given normalized transmittance. The best-fit is performed using any one of a number of methods that are well known to those of ordinary skill in the art. In accordance with one or more embodiments of the present invention, polynomials are generated for n=1 up to n=7 for propane, CO and CO₂, and the polynomial providing the best fit to the data is chosen for each of these gases. Next, the coefficients for the chosen polynomial are stored in memory, for example and without limitation, in non-volatile memory 641 for later use. Then, utilizing a gas having a certified predetermined concentration of hexane, a concentration of the hexane is determined. Next, a hexane:propane equivalency factor (PEF) is determined, and stored in memory, for example and without limitation, in non-volatile memory 641 for later use. The PEF is a multiplicative constant that is used to convert the polynomial obtained using propane to an appropriate polynomial that can be used to determine the concentration of hexane.

In accordance with one or more further embodiments of the present invention, use of gas analyzer 600 may entail the use of a “field” calibration process. In accordance with such further embodiments of the present invention, the field calibration process (sometimes referred to as a “span” operation) entails making measurements of concentrations using a certified gas having predetermined concentrations of particular gases, and then determining a multiplicative factor (sometimes referred to in the art as a “span”) to apply to the final calculation performed by gas analyzer 600, i.e., after correction for pressure and temperature.

As one can readily appreciate from the above, one or more embodiments of the present invention provide method and apparatus that determine concentrations of one or more gases, including oxygen, that are associated with but which are not limited to emissions from vehicles using internal combustion engines. Further, in accordance with one or more such embodiments, the apparatus provides to a user through a display, wired or wireless analog voltage, or wired or wireless binary communication, the concentrations of such gases. Still further, in accordance with one or more such embodiments, the apparatus provides the concentrations in any output format in update intervals of less than half of a second, for example and without limitation, at a rate of 10 Hz, which rate is limited by the speed of the various elements such as, for example and without limitation, the cycle time of microprocessor 634.

As is well known, in order to calculate the value of lambda from measurements of combustion by-products in the exhaust of a gasoline engine, a mathematical model is necessary. In accordance with one or more embodiments of the present invention, an equation used to calculate lambda is derived from a model that is commonly referred to in the industry as Brettschneider's λ equation. In particular, in accordance with one or more embodiments of the present invention, the following algorithm is used. If C(O₂) is greater than 0.005, then lambda=1. Otherwise, lambda=N/D, where N=C(CO₂)+C(CO)/2+C(O₂)+(1.9*(3.5/(3.5+C(CO)/C(CO₂))); and D=1.425*(C(CO₂)+C(CO)+0.0006*C(HC)).

Although various embodiments that incorporate the teachings of the present invention have been shown and described in detail herein, those skilled in the art can readily devise many other varied embodiments that still incorporate these teachings.

What is claimed is:

1. An analyzer of a multiplicity of gases in a sample gas that comprises:
a source of infrared radiation;
a multiplicity of band-pass filters that transmit wavelengths of the infrared radiation that fall within a band-pass of the multiplicity of band-pass filters, wherein one of the band-pass filters is a reference band-pass filter having a center band-pass wavelength and band-pass whereby none of the multiplicity of gases absorbs infrared radiation transmitted by the reference filter, and an opaque area that completely blocks the infrared radiation;
a movement mechanism that places the band-pass filters and the opaque area in front of the infrared radiation at predetermined times, and includes a location pickup mechanism;
a location pickup mechanism detector that detects the location pickup mechanism and generates movement mechanism timer signals;
a sample cell through which the sample gas travels, which sample cell is disposed in a path of the infrared radiation after it has passed through the band-pass filters;
a gas temperature sensor that detects a temperature of the sample gas in the sample cell and generates a temperature signal;
a pressure transducer that detects a pressure of the sample gas in the sample cell and generates a pressure signal;
a detector that detects infrared radiation that has passed through the sample cell and generates detector signals; and
a controller that analyzes the movement mechanism timer signals, the detector signals, the temperature signal, and the pressure signal;
wherein the controller comprises modules that:
analyze the movement mechanism timer signals to determine times at which the infrared radiation will impinge upon the band-pass filters and the opaque area, and reads the detector signals at such times;
determine measures of energy as differences between values of the detector signal at times the infrared radiation impinges upon the band-pass filters and the value of the detector signal at the time the infrared radiation impinges upon the opaque area;
determine transmittances as the measures of energy divided by the measure of energy for the reference filter;
calculate concentrations of the gases using polynomial equations that are a function of the transmittances; and
correct the concentrations using Boyle's law using the temperature signal and the pressure signal.

2. The analyzer of claim 1 wherein the controller further comprises modules that operate before the module that calculates the concentrations using polynomial equations and that:
normalize the transmittances using transmittance data obtained from measurements made using a sample gas that does not contain any of the gases to be analyzed; and
correct the transmittances for cross-talk.

3. The analyzer of claim 1 wherein the controller further comprises a module that corrects the corrected concentrations using a span.

4. The analyzer of claim 1 wherein a diameter of an inner volume of a portion of the sample cell has a minimum at a first end and a maximum at a second end.

5. The analyzer of claim 4 wherein the inner diameter is linearly increased from the first end to the second end.

6. The analyzer of claim 4 wherein inner walls of the sample cell are highly reflective.

7. The analyzer of claim 1 which further comprises a radial gas inlet mechanism and a radial gas outlet mechanism for sample gas entering and exiting, respectively, the sample cell.

8. The analyzer of claim 7 wherein the sample gas enters and exits the sample cell directly against radiation windows disposed at ends of the sample cell.

9. The analyzer of claim 1 which further comprises an oxygen sensor disposed to detect oxygen in the sample gas.

10. The analyzer of claim 1 wherein the movement mechanism comprises a chopper wheel and a chopper motor wherein the band-pass filters and the opaque area are disposed at a constant radius from a center of the chopper wheel.

11. The analyzer of claim 1 wherein the chopper motor is a miniature chopper motor.

12. The analyzer of claim 10 wherein the module that analyzes the movement mechanism timer signals determines a time interval between rotations, and from predetermined locations of the filters and the opaque area it determines times at which the infrared radiation will impinge upon each of the filters and the opaque area, and it reads the detector signals at such times.

13. The apparatus of claim 1 wherein the module that analyzes the movement mechanism timer signals to determine times at which the infrared radiation will impinge upon each of the band-pass filters and the opaque area, and reads the detector signals at such times; reads the detector signals to obtain a multiplicity of values of the detector signal for each of the filters and the opaque area.

14. The apparatus of claim 13 wherein the module that analyzes the movement mechanism timer signals filters the multiplicity of values for each of the filters and the opaque area.

15. The analyzer of claim 10 wherein the module that analyzes the movement mechanism timer signals to determine times at which the infrared radiation will impinge upon each of the band-pass filters and the opaque area, and reads the detector signals at such times; reads the detector signals to obtain a multiplicity of values of the detector signal for each of the filters and the opaque area.

16. The apparatus of claim 15 wherein the module that analyzes the movement mechanism timer signals filters the multiplicity of values for each of the filters and the opaque area.

17. The apparatus of claim 16 wherein the filter comprises calculating an average of some of the detector signal values obtained during a current rotation of the chopper wheel with some of the detector signal values obtained during a previous rotation of the chopper wheel.

18. The apparatus of claim 9 wherein the controller receives signals from a tachometer and the controller further comprises a module that determines a rotational speed of a combustion engine in response to the tachometer signals.

19. The apparatus of claim 18 wherein the multiplicity of gases include CO₂, CO, and HC and wherein the controller further comprises a module that computes lambda, i.e., a stoichiometric or ideal air-fuel ratio that provides a complete combustion normalized to value of 1.0.

20. The apparatus of claim 19 wherein the controller further comprises a module that computes an air-fuel ratio.

21. The analyzer of claim 9 wherein the controller further comprises a display and a module that displays the further corrected concentrations thereon.

22. The analyzer of claim 21 wherein the controller further comprises a module that stores the further corrected concentrations, and the oxygen concentration.
